(19) United States
(12) Patent Application Publication
(10) Pub. No.: US 2026/0364432 A1
(43) Pub. Date: Nov. 19, 2026

(54) MOTION SIMULATION DEVICE

(71) Applicant: BENQ CORPORATION, Taipei City (TW)

(72) Inventor: Chih-Pen Huang, Taipei City (TW)

(73) Assignee: BENQ CORPORATION, Taipei City (TW)

(21) Appl. No.: 19/661,729

(22) Filed: Apr. 29, 2026

(30) Foreign Application Priority Data
May 16, 2025 (TW) 114118447

(51) Int. Cl. A63B 71/06; A63B 24/00; G06T 7/521; G06T 7/73; G06V 40/20; A63B 102/32

(52) U.S. Cl. CPC A63B 71/0622; A63B 24/0006; G06T 7/521; G06T 7/73; G06V 40/23; G06V 40/28; A63B 2024/0009; A63B 2102/32; A63B 2220/05; A63B 2220/806; G06T 2207/30196; G06T 2207/30224

(57) ABSTRACT

A motion simulation device includes a camera module, a projection module and an operation processor. The camera module is used to capture a top view image. The projection module is integrated with the camera module. The operation processor is electrically connected to the camera module and the projection module. The operation processor executes an artificial intelligence algorithm to mark a specific position of a user as at least one feature point on the top view image, and set a recognition model according to the at least one feature point, so that the recognition model can analyze the top view image for defining a spatial geometric relation of the user to provide motion information of the user, and setting the motion information and a recommendation derived from the motion information as user information, so as to drive the projection module to project a projection image containing the user information.

### BACKGROUND OF THE INVENTION

### 1. Field of the Invention

The present invention relates to a motion simulation device, and more particularly, to a motion simulation device of using artificial intelligence to build the recognition model.

### 2. Description of the Prior Art

With the advanced technology, indoor simulated sports gradually become popular; for example, the indoor simulated golf course is more well-known because it requires a much smaller area than the real golf course. The conventional indoor simulated golf course projects the course image onto a projection screen in front of the user, and analyzes the speed, position, and distance of the golf ball, to provide batting information for the user. For acquiring motion information of the user, the conventional indoor simulated golf course disposes multiple sensors on specific places of the user to detect the movement. The sensors are accelerometers or gyroscopes, and typically placed on the user's head, hands, feet, and shoulders, which is uncomfortable and inconsistent with normal exercise habits, and creates extra burden and impacts exercise effectiveness. Therefore, design of a golf indoor simulation device that can quickly and accurately detect the motion information without additional sensors is an important issue in the sports equipment industry.

### SUMMARY OF THE INVENTION

The present invention provides a motion simulation device of using artificial intelligence to build the recognition model for solving above drawbacks.

According to one embodiment, a motion simulation device includes a camera module, a projection module and an operation processor. The camera module is adapted to capture a top view image. The projection module is integrated with the camera module. The operation processor is electrically connected to the camera module and the projection module,. The operation processor is adapted to execute an artificial intelligence algorithm for marking a specific position of a user as at least one feature point on the top view image, set a recognition model according to the at least one feature point, and utilize the recognition model to analyze the top view image for defining a spatial geometric relation of the user to provide motion information of the user, and setting the motion information and a recommendation derived from the motion information as user information, so as to drive the projection module to project a projection image containing the user information.

The motion simulation device of the present invention can utilize the top view image acquired by the camera module to execute image pre-processing operation for extracting and marking the features, such as a specific position of the user, and perform the artificial intelligence algorithm to automatically analyze the feature and set the recognition model for loading into the operation processor, by replacing the conventional sensor wore on the human body. Then, the motion simulation device can transmit the top view image immediately captured by the camera module to the recognition model, and the recognition model can analyze the top view image to define a spatial geometric relation of the user for providing the motion information of the user, and set the motion information and a recommendation derived from the motion information as the user information, which is based on the immediately-captured top view image. The projection module can project the projection image containing the user information onto the projection region where the user stands, so that the user can view and observe the user information of the projection image as a prompt, and the user can further swing the golf club to control the virtual button within the projection image for adjusting the parameter setting of the motion simulation device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an application diagram of a motion simulation device according to an embodiment of the present invention.

FIG. 2 is a functional block diagram of the motion simulation device according to the embodiment of the present invention.

FIG. 3 is a diagram of a projection image generated by the motion simulation device according to the embodiment of the present invention.

### DETAILED DESCRIPTION

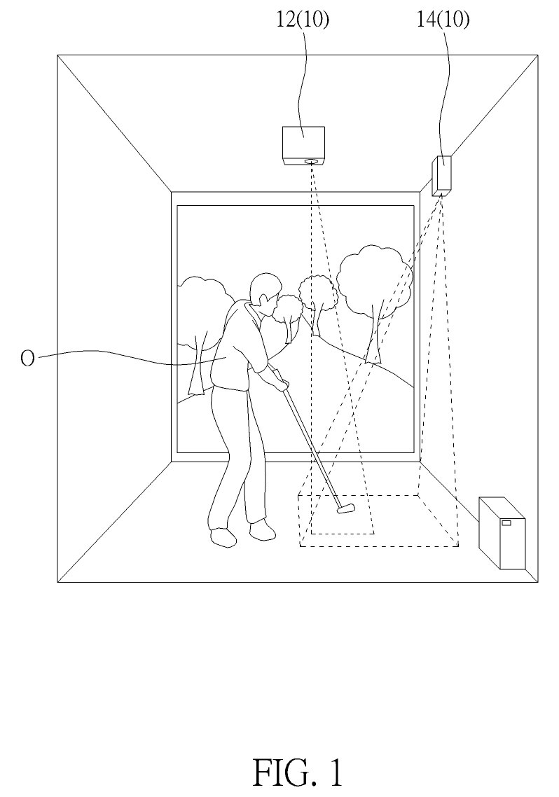

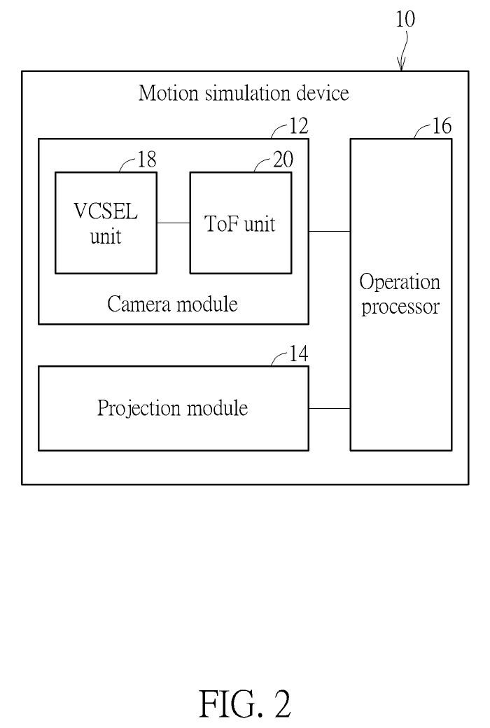

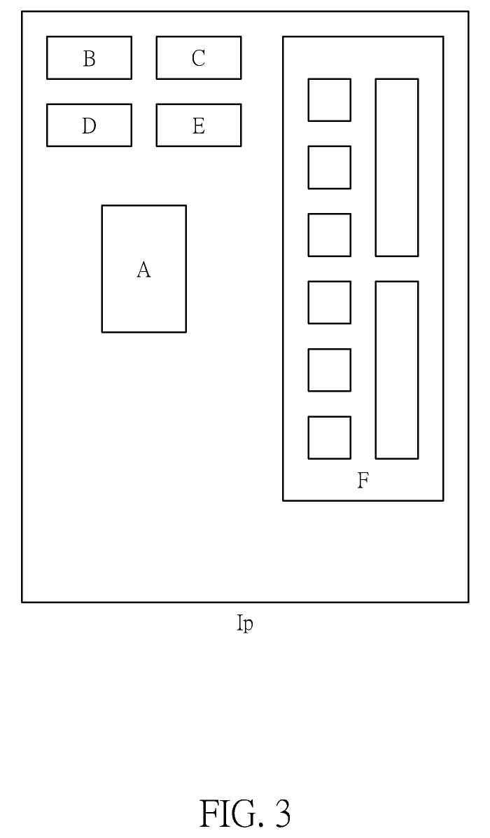

Please refer to FIGS. 1-3. FIG. 1 is an application diagram of a motion simulation device 10 according to an embodiment of the present invention. FIG. 2 is a functional block diagram of the motion simulation device 10 according to the embodiment of the present invention. FIG. 3 is a diagram of a projection image Ip generated by the motion simulation device 10 according to the embodiment of the present invention. In the present invention, the motion simulation device 10 can be a golf indoor simulation device applied for an external computer device (which is not shown in the figures). The external computer device can be, but not be limited to, a desktop computer or a notebook computer. The motion simulation device 10 can be electrically connected to the external computer device in a wired manner or in a wireless manner. The motion simulation device 10 can be a projection apparatus with a motion analysis function, which can analyze a body gesture, variation of a golf club, and/or batting results of a user O stayed in a projection region, and transmit an analysis result to the external computer device for further operation.

The motion simulation device 10 can include a camera module 12, a projection module 14 and an operation processor 16. The camera module 12 can capture a top view image from directly above the user O. The projection module 14 can be integrated with the camera module 12, and may be electrically connected to camera module 12 in the wired manner or in the wireless manner. The camera module 12 and the projection module 14 can be two independent units with a signal transmission channel, as shown in FIG. 1, or can be integrated into the same case (which is not shown in the figures). The operation processor 16 can be electrically connected to the camera module 12 and the projection module 14. The operation processor 16 can perform an artificial intelligence algorithm to analyze the top view image captured by the camera module 12 to acquire user information (e.g., the body gesture of the user O, and a golf club and a golf ball operated by the user O), instead of the motion detection function of a conventional motion detector. The operation processor 16 can further utilize the projection module 14 to project the projection image Ip that contains the user information onto the projection region; the user O can view the projection image Ip for reference.

The camera module 12 can optionally include a vertical cavity surface emitting laser (VCSEL) unit 18 and a time of flight (ToF) unit 20 for a depth sensing function. The VCSEL unit 18 can generate and project a structured light laser signal onto the user O and an object (e.g., the golf club) held by the user O. The ToF unit 20 can receive a reflection result of the structured light laser signal to form and transmit a point cloud structure diagram to the operation processor 16. The operation processor 16 can analyze the reflection result and acquire the depth information of the top view image based on spatial datum points of the point cloud structure diagram, and the depth information can indicate three-dimensional shapes of the hands and feet of the user O, and the golf club and the golf ball operated by the user O. The projection module 14 can be the common projection apparatus, and a detailed description is omitted herein for simplicity.

Regarding execution of the motion simulation device 10, the operation processor 16 can utilize the camera module 12 to capture and collect a large number of the top view images, or to receive the large number of the top view images from an external device, and then perform the artificial intelligence algorithm to analyze the top view image and mark a feature point. In the embodiment, the motion simulation device 10 can perform the artificial intelligence algorithm to analyze the full content of the top view image for extracting the feature point. For example, the feature point can be a toe of the user O, a club surface end point and a handle end point of a golf club held by the user O, and/or a golf ball near the golf club held by the user O. The foresaid end point can be interpreted as a side or a corner of the specific object. As if the camera module 12 has the depth sensing function, the artificial intelligence algorithm can be further performed to analyze the depth information of the top view image to acquire a hand feature and an endpoint of the shoulder of the user O, so as to acquire the hand gesture and/or a shoulder rotation trajectory.

In other possible embodiment, the motion simulation device 10 may utilize the artificial intelligence algorithm to perform object recognition on the top view image for defining a marking frame based on a preset feature, or utilize the artificial intelligence algorithm to perform motion detection on the top view image for defining the marking frame based on the preset feature, and then analyze image content of the marking frame to mark the feature point at a corresponding position of the preset feature. That is to say, the motion simulation device 10 can perform static object detection or dynamic object detection on the top view image via the artificial intelligence algorithm, to find out the preset feature of the user O or the object held by the user O (e.g., the feet, the hands, the golf club, the golf ball, and the shoulder) for setting the marking frame. The image content of the marking frame can be further analyzed to mark position relevant to the toe of the user O, the hand holding posture of the user O, the club surface of the golf club, the top end of the handle of the golf club, and/or the end points of the shoulder as the feature point.

Then, the motion simulation device 10 can perform the artificial intelligence algorithm to analyze the top view image and acquire a size parameter and an angle parameter of the top view image. The feature point extracted from the top view image, and the size parameter and the angle parameter can be used to define a spatial geometric relationship of the user O and the object held by the user O for setting a recognition model. The size parameter can include, but not be limited to, a length and a width of the top view image, a length and a width of the projection image Ip generated by the projection module 14, and a distance of the projection module 14 relative to the user O (or relative to the projection region where on the user O is located). The foresaid angle parameter can include, but not be limited to, a tilted angle of the user O or the object (e.g., the golf club and/or the golf ball) held by the user O relative to the projection module 14, an included angle of a connection line between toes of the user’s feet relative to a reference line, an included angle of a connection line between the user’s hands relative to the reference line, an included angle of a connection line between the user’s shoulders relative to the reference line, and an included angle of the club surface of the golf club relative to the reference line.

When the recognition model is set up, the motion simulation device 10 can drive the camera module 12 to capture the top view image of the user O in motion, and transmit the top view image to the recognition model for analysis. The recognition model can acquire motion information (e.g., the body gesture of the user O, the variation of the golf club, and/or the batting result) in accordance with setting parameters during model establishment, and convert the motion information into the user information (e.g., an attack position of the user O, the included angle of the feet of the user O relative to the reference line, the included angle of the hands of the user O relative to the reference line, the included angle of the club surface of the golf club held by the user O relative to the reference line). Final, the motion simulation device 10 can perform the artificial intelligence algorithm to compute the distance of the projection module 14 relative to the projection region, and compute a reasonable size of the projection image Ip based on the foresaid distance, and therefore drive the projection module 14 to project the projection image Ip set as the reasonable size and containing the user information onto the projection region.

The motion simulation device 10 can immediately acquire the user information of the user O, and convert the user information into the projection image Ip and project the projection image Ip onto the projection region near the user O. The user O can view the projection image Ip at any time to decide whether to adjust his or her body gesture and/or the batting position; the artificial intelligence algorithm of the motion simulation device 10 can analyze the user information to generate adjustment suggestion, and project the projection image Ip including the adjustment suggestion onto the projection region for the user O. Besides, the projection image Ip projected by the motion simulation device 10 can include a series of virtual buttons. The user O can swing the golf club above the projection image Ip to control command input of the virtual buttons, so as to adjust relevant parameter settings of the motion simulation device 10.

During generation of the top view image, the motion simulation device 10 can collect the large number of top view images, and perform the artificial intelligence algorithm to analyze and recognize the large number of top view images; no more top view images are collected to update model parameters of the recognition model once the recognition model is built. The motion simulation device 10 can drive the camera module 12 to capture the new top view image for generating the projection image Ip that contains the user information. In other possible embodiment, after the recognition model is set up, the motion simulation device 10 can drive the camera module 12 to capture the top view image, which is not only used to generate the projection image Ip containing the user information, but also be analyzed and recognized to continuously update the model parameters of the recognition model. Collection of the top view image and update of the recognition model are not limited to the foresaid embodiment, and depend on a design demand.

As shown in FIG. 3, the virtual button of the projection image Ip can at least include projection patterns A~E. The projection pattern A can be located on a middle of the projection region where on the user O stands, and can be preset to place the golf ball. The left side and the right side of the projection pattern A can be position where the user O may stand. The motion simulation device 10 can analyze relation between the user O and the projection pattern A to determine the user O is in the left standing posture or the right standing posture, and further to automatically adjust parameter settings of the standing posture. The user information represented by the projection pattern B can be the included angle of the connection line between the user’s shoulders relative to the reference line. The motion simulation device 10 can use the projection pattern B to analyze and show a shoulder rotation trajectory of the user O when batting the golf ball, so the user O can realize whether the shoulders are level before batting the gold ball, and further realize a body rotation angle of the user O after batting the gold ball. The user information represented by the projection pattern C can be the hand holding posture of the user O and position of the hands holding the golf club. The motion simulation device 10 can analyze the projection pattern C to decide whether the hand holding posture is correct, and may further provide suggestion of the correctly holding posture via the projection pattern C. The user O can view and observe the user information of the projection patterns B and C for self-adjustment.

Moreover, the projection pattern D can represent a current type of the golf club. When changing the golf club, the user O can switch the type of the golf club via the virtual button on the projection pattern D, so as to facilitate the correct recognition of following applications (e.g., analysis of a direction and a distance of the golf ball after batting). The projection pattern E can include, but not be limited to, the included angle of the connection line between the toes of the user O relative to the reference line, or the included angle of the connection line between the hands of the user O relative to the reference line, or the included angle of the club surface of the golf club relative to the reference line. The projection pattern F within the projection image Ip can be the virtual button or the virtual keyboard. Functions of the virtual button can include, but not be limited to, a selection key for the left standing posture, a selection key for the right standing posture, a rotation key, a setting key, a switching key for the golf club. The functions, positions and numbers of the projection patterns E and F can depend on the design demand of the motion simulation device 10, and are not limited to the embodiment shown in FIG. 3.

In conclusion, the motion simulation device of the present invention can utilize the top view image acquired by the camera module to execute image pre-processing operation for extracting and marking the features, such as a specific position of the user, and perform the artificial intelligence algorithm to automatically analyze the feature and set the recognition model for loading into the operation processor, by replacing the conventional sensor wore on the human body. Then, the motion simulation device can transmit the top view image immediately captured by the camera module to the recognition model, and the recognition model can analyze the top view image to define a spatial geometric relation of the user for providing the motion information of the user, and set the motion information and a recommendation derived from the motion information as the user information, which is based on the immediately-captured top view image. The projection module can project the projection image containing the user information onto the projection region where the user stands, so that the user can view and observe the user information of the projection image as a prompt, and the user can further swing the golf club to control the virtual button within the projection image for adjusting the parameter setting of the motion simulation device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A motion simulation device comprising:
a camera module adapted to capture a top view image;
a projection module integrated with the camera module; and
an operation processor electrically connected to the camera module and the projection module, the operation processor being adapted to execute an artificial intelligence algorithm for marking a specific position of a user as at least one feature point on the top view image, set a recognition model according to the at least one feature point, utilize the recognition model to analyze the top view image for defining a spatial geometric relation of the user to provide motion information of the user, and setting the motion information and a recommendation derived from the motion information as user information, so as to drive the projection module to project a projection image containing the user information.

2. The motion simulation device of claim 1, wherein the operation processor analyzes the top view image via the artificial intelligence algorithm to extract the at least one feature point.

3. The motion simulation device of claim 2, wherein the motion simulation device is a golf indoor simulation device, the at least one feature point is a toe of the user of the golf indoor simulation device, and/or a club surface end point and a handle end point of a golf club held by the user.

4. The motion simulation device of claim 1, wherein the operation processor analyzes the top view image via the artificial intelligence algorithm to define a marking frame based on a preset feature, and further analyzes the marking frame to mark the at least one feature point in accordance with a corresponding position of the preset feature.

5. The motion simulation device of claim 4, wherein the motion simulation device is a golf indoor simulation device, the preset feature is feet of a user of the golf indoor simulation device, and/or a golf club and a golf ball operated by the user.

6. The motion simulation device of claim 1, wherein the operation processor utilizes the artificial intelligence algorithm to set the recognition model in accordance with the at least one feature point and a size parameter and an angle parameter of the top view image.

7. The motion simulation device of claim 1, wherein the operation processor utilizes the artificial intelligence algorithm to compute a distance of the projection module relative to the projection region, and computes a size of a projection image based on the distance, so as to drive the projection module to project the projection image based on the size and containing the user information onto the projection region.

8. The motion simulation device of claim 1, wherein the motion simulation device is a golf indoor simulation device, the user information is an attack position of a user of the golf indoor simulation device standing inside a projection region, an included angle of feet of the user relative to a reference line, an included angle of hands of the user relative to the reference line, another included angle of a club surface of a golf club held by the user relative to another reference line, and/or a series number of the golf club.

9. The motion simulation device of claim 1, wherein the camera module comprises a vertical cavity surface emitting laser (VCSEL) unit and a time of flight (ToF) unit, the VCSEL unit generates a structured light laser signal, the ToF unit receives a reflection result of the structured light laser signal, and the operation processor analyzes the reflection result to acquire depth information of the top view image.

10. The motion simulation device of claim 9, wherein the motion simulation device is a golf indoor simulation device, the operation processor analyzes the depth information via the artificial intelligence algorithm to acquire a hand gesture and/or a shoulder rotation trajectory of a user of the golf indoor simulation device.
